(19) United States
(12) Patent Application Publication
(10) Pub. No.: US 2011/0179108 A1
(43) Pub. Date: Jul. 21, 2011

(54) System for Aggregating Information and Delivering User Specific Content

(75) Inventors: Michael W. Sorenson, Cambridge, MA (US); Timothy J. Finley, Leesburg, VA (US)

(73) Assignee: International Business Machines Corporation, Armonk, NY (US)

(21) Appl. No.: 12/691,545

(22) Filed: Jan. 21, 2010

(51) Int. Cl. G06F 15/16; G06F 12/08

(52) U.S. Cl. 709/203; 711/118; 711/E12.017

(57) ABSTRACT

Systems and methods for aggregating information and delivering user specific content having at least one system server computer having a plurality of data feeds operatively coupled thereto through which the system receives new content. The system has least one content storage device and global cache member coupled to the plurality of client computers through the server. The method includes storing content received from an external source on the content storage device and defining and storing at least one user account content delivery preference on a server computer. The method also includes receiving new content from the external source, storing the new content data to a system cache memory and sorting the content and new content according to at least one user account preference stored on the server computer. The method also includes storing new content data specified in the user account delivery preferences in a user index file associated with the user account on the server computer and presenting/delivering content specified in the user index and new content consistent with the user account preferences contained in the cache memory, to the user when the user request content or logs on to the network.

### I. FIELD OF THE INVENTION

This invention relates in general to the field of computer systems and data management and in particular to the field of aggregating and delivering user specific content relevant to a particular user in a network environment.

### II. DESCRIPTION OF THE PRIOR ART

U.S. Pat. No. 6,239,389 issued to Weber discloses method, apparatus and article of manufacture for filtering a notification message from a database. A database is received by the system. The database is logically partitioned into a first partition and a second partition, the first partition having a first object instance, the second partition having a second object instance. The notification message is transmitted from the database to a message recipient. The notification message is filtered based upon a notification message type and a viewage table. In one embodiment, a message channel can be created having a database identifier attribute and a message type attribute. The notification message is transmitted between the database and the message channel if the notification message matches the message channel database identifier attribute and the message type attribute. The notification message is transmitted between the message channel and the message recipient if the target partition ID of the notification message matches a partition ID in the viewage table.

U.S. Pat. No. 6,330,555 also issued to Weber discloses a method, apparatus and article of manufacture for enabling a view of data across a database. A database containing data to be viewed is received by the system. The database is logically partitioned into a partition based upon a characteristic of the data to be viewed, the partition having a partition viewage table and a set of objects. An entry point is defined in the database for the view of data, the entry point having an entry point viewage table. The view of data is enabled by generating a set of partitions by recursively following the entry point viewage table and the partition viewage table to referenced partitions.

U.S. Pat. No. 7,349,894 issued to Barth et al., discloses method and apparatus are provided for a dynamic information connection engine. User actions are detected on at least one client system. In response, a determination is made whether the user is searching for supported information. When the user is searching for supported information, information is extracted electronically from third party web sites, direct supplier connections, and intermediate databases. Potential information suppliers are automatically selected in response to the detected user search. Queries are formulated from the user search and transferred to each selected supplier over a network coupling. The queries include a request for information. Responses are received from the suppliers, and the responses are used to generate a result list for the user. The result list includes information and query status information. Further, an electronic link may be provided to a web site of each supplier from which the information was derived.

Published Japanese Patent Abstract JP2008-060772-A discloses a contents distribution system and distribution method in which concerned parties can view and listen to secret contents, and others except the concerned parties can not view and listen to, by easily distinguishing the concerned parties in an information network in which open contents and secret contents are mixed. The contents distribution system and its distribution method are composed so that viewing and listening restriction of charged contents is released by a first release means which requires a viewing and listening restriction release code, and viewing and listening restriction of secret contents is released by a second release means which requires an identification code consisting of an ID and a password in the receiving servers.

### III. SUMMARY OF THE INVENTION

Disclosed is a system for aggregating information and delivering user specific content having at least one system server computer having a plurality of data feeds operatively coupled thereto through which the system receives new content and at least one content storage device coupled to a plurality of client computers through the server computer. The system further includes at least one system cache type storage device coupled to the plurality of client computers through the server computer and a plurality of subscribers, each of the subscriber having a unique user account through which the subscriber uses one of the plurality of client computers to access particular content stored in the content storage device, the user account specifying the subscriber's preference data as well as a user index associated with each the unique user account, the user index containing content data specifying particular content according to the subscribers' preferences.

The system server processes the new content received through the data feed by searching, classifying and aggregating the new content received by the system server contained in the system cache and in the at least one content storage device, based on each subscriber's preference data, and delivers user specific content to each subscriber through a client computer coupled to the network when the subscriber logs on to the network.

Also disclosed is a method for aggregating selected information and delivering user specific content from a server computer to a user via a client machine coupled to a computer network including storing content received from at least one external source to a plurality of content storage devices coupled to the network server, storing content received from at least one external source to a system cache memory and associating a specific user account to each of a plurality of users. The method also includes defining a user account interest model for each of the plurality of users, populating a user index associated with each user account with content data based on the account interest model, searching the cache memory for content identified in each the account interest model and retrieving content identified in each the account interest model from the cache memory as well as content identified by the account index data from the plurality of storage devices and merging the content retrieved from the cache memory with the content retrieved from the plurality of storage devices for each user account, as well as presenting to each user merged content, associated with the user's particular account interest model, when the user logs on to the network.

Also disclosed is a method aggregating selected information and delivering user specific content from a server computer to a user via a client machine coupled to a computer network including storing content received from at least one external source to a plurality of content storage devices coupled to the network server, storing content received from at least one external source to a system cache memory and associating a specific user account to each of a plurality of users. The method also includes defining a user account interest model for each of the plurality of users, populating a user index associated with each user account with content data based on the account interest model, searching the cache memory for content identified in each the account interest model and retrieving content identified in each the account interest model from the cache memory as well as content identified by the account index data from the plurality of storage devices and merging the content retrieved from the cache memory with the content retrieved from the plurality of storage devices for each user account, as well as presenting to each user merged content, associated with the user's particular account interest model.

Also disclosed is a method for aggregating selected information and delivering user specific content from a server computer to a user via a client machine coupled to a computer network including storing content received from an external source on a content storage device coupled to the network server, associating a specific user account to the user, defining at least one user account content delivery preference and storing at least one user account content delivery preference on a server computer. The method further includes receiving a plurality of new content from the external source and storing the new content data to a system cache memory as well as sorting the content and new content according to at least one user account preference stored on the server computer and storing new content data specified in the user account delivery preferences in a user index file associated with the user account on the server computer.

The method also includes removing the new content, from the system cache memory when the content data associated with the new content, is loaded onto the user index file and presenting the content specified in the user index and new content consistent with the user account preferences contained in the cache memory, to the user when the user logs on to the network.

### IV. BRIEF DESCRIPTION OF THE DRAWINGS

In order to describe the manner in which the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a diagram of an exemplary system in which the disclosed invention is implemented.

FIG. 2 is a block diagram illustrating the exemplary flow of new information into the system.

FIG. 3 is an exemplary flowchart showing the flow of new information into the system.

FIG. 4 is a block diagram illustrating the exemplary flow of information pre-processed and retrieved for an inactive user.

FIG. 5 is an exemplarily flowchart showing the storage, merging, and delivery of pre-processed information to a subscriber at logon.

FIG. 6 is a block diagram illustrating the exemplary flow of information retrieved for an active user.

### V. DETAILED DESCRIPTION OF THE EMBODIMENTS

Various embodiments are discussed in detail below. While specific implementations of the disclosed technology are discussed, it should be understood that this is done for illustration purposes only. A person skilled in the relevant art will recognize that other components and configurations may be used without departing from the spirit and scope of the invention.

This disclosure relates to systems and methods for aggregating information, and delivering to a plurality of subscribers user specific content based on or relating to content specified in each subscriber's account. The content aggregation and delivery may anticipate or be in response to requests for the deliver of content. The subscriber account specifies the content needs of each user and may or may not be unique to each user. The system pre processes newly received content, by storing the content as well as aggregating and storing metadata relating to new content in a plurality of subscriber indices containing content metadata determined relevant to individual user accounts. Each subscriber index is constructed, based on the user preferences as set fourth in the subscriber data. This subscriber data is typically specified prior to the server receiving a user's request for the delivery of new content. When the subscriber log onto his or her account, the metadata stored in his or her user index is retrieved and the new content relating thereto stored in the memory unit and the cache memory is presented to the user.

In other embodiments, when the user is active on the system, new content received by the system is again pre-processed to determine if the new content received is consistent with the subscriber preference data. Content determined to be consistent with the active user's subscriber preference data is retrieved, sorted, and indexed, for quick and efficient delivery to the user upon receipt of a request for content.

Pre processing content, prior to receiving a request for the delivery of content, allows the system to efficiently use periods of low system demand, or user account inactivity, to sort and aggregate information relevant to the various subscribers thus maximizing the system search efficiency during peak demand periods.

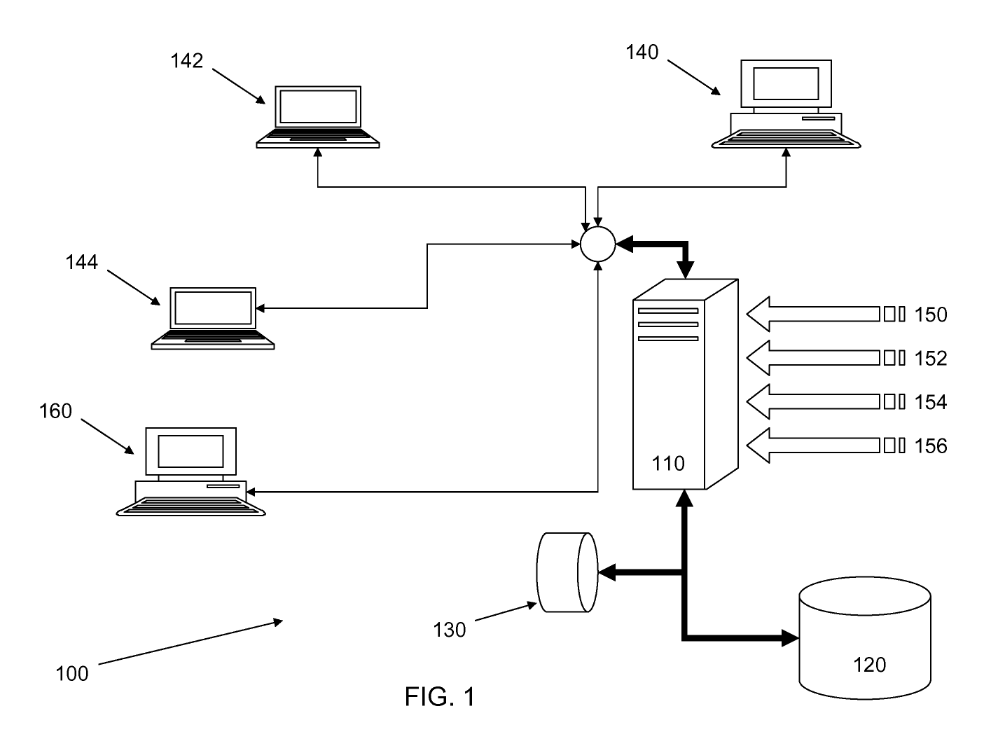

Referring now to the figures, wherein like reference number denote like elements, FIG. 1 shows a diagram of an exemplary system 100 in which the disclosed invention is implemented. The exemplary system 100 features a system server computer 110, having a plurality of data feeds 150-156, operatively coupled thereto through which the system receives new content.

The content received can be any information, data, or reports received by the server over the network, through a grid, or from a reporting agency.

The system 100 features at least one content storage device 120 coupled to a plurality of client computers 140, 142, 144, 160 through the server computer 110. The system 100 further includes at least one system cache type storage device 130 coupled to the plurality of client computers 140, 142, 144, 160 through the server computer 110 and a plurality of subscribers. As, conventional, each subscriber has a unique user account through which he or she uses one of the plurality of client computers to access particular content stored in the content storage device 120. In other embodiments a plurality of user accounts may be associated with a single subscriber.

The user account specifies the particular subscriber's content preference data from which a user index is created. The server 110 creates a user index associated with each the unique user account. The user index is loaded with content data specifying the particular content contained in the content storage device 120, determined by the server 110 to be consistent with the subscriber's preferences as set forth by the subscriber content preference data according to that particular subscribers' interest or content requirements. This is performed for each user account. In at least one embodiment the content data includes a plurality of data pointers that specify the location of particular content stored in one or more content storage devices 120. Content data stored in each user index may include metadata, which may include dates, scores, ranking, etcs, as well as pointers to the data in the storage system. New content is received by the server 110 through one or more data feeds 150, 152, 154 and 156 that are operatively coupled to the server. The form and throughput of the data feeds may vary.

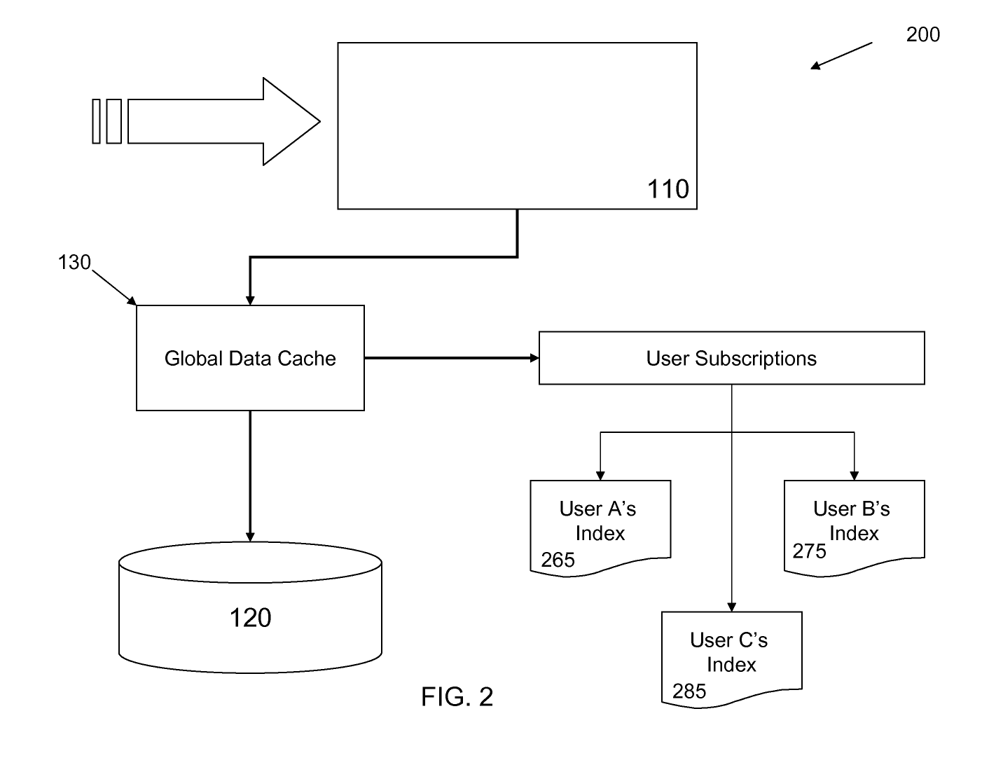

Referring now to FIG. 2 with continued reference to FIG. 1, FIG. 2 shows a block diagram of the flow of new information into the exemplary system 200. The example embodiment of FIG. 2 includes a system server computer 110 having a plurality of data feeds 150, 152, 154, and 156 operatively coupled thereto, through which the system 100 receives new content. The system 100 features a content storage device 120 coupled to a plurality of client computers 140-144, and 160, through the server computer 110. The system further includes a system cache type storage device 120 coupled to the plurality of client computers 140, 142, 144, 160 through the server computer 110 and a plurality of subscribers (not shown).

Preferably, each subscriber has a unique user account through which the subscriber uses one of the plurality of client computers 140, 142, 144, 160 to access particular content stored in the content storage device. The user account specifies each subscriber's content preferences via subscriber preference data, as well as a user index associated with each the unique user account. (Exemplarily user indices A, B, and C). Each user index 265, 275, 285 contains content data specifying particular content according to the subscribers' content preferences. The system server 110 pre-processes new content received through the data feed 150, 152, 154, 156 by searching, classifying and aggregating the new content received by the system server 110 contained in the system cache 130 and in the at least one content storage device 120, based on each subscriber's preference data, and delivers user specific content to each subscriber through a client computer coupled to the network when an active subscriber request content, or when an inactive subscriber logs on to the network.

In other embodiments the system may feature a plurality of servers coupled in a grid or other network and/or a plurality of cache type memory devices, and/or a plurality of content storage devices operatively coupled to one or more server computers.

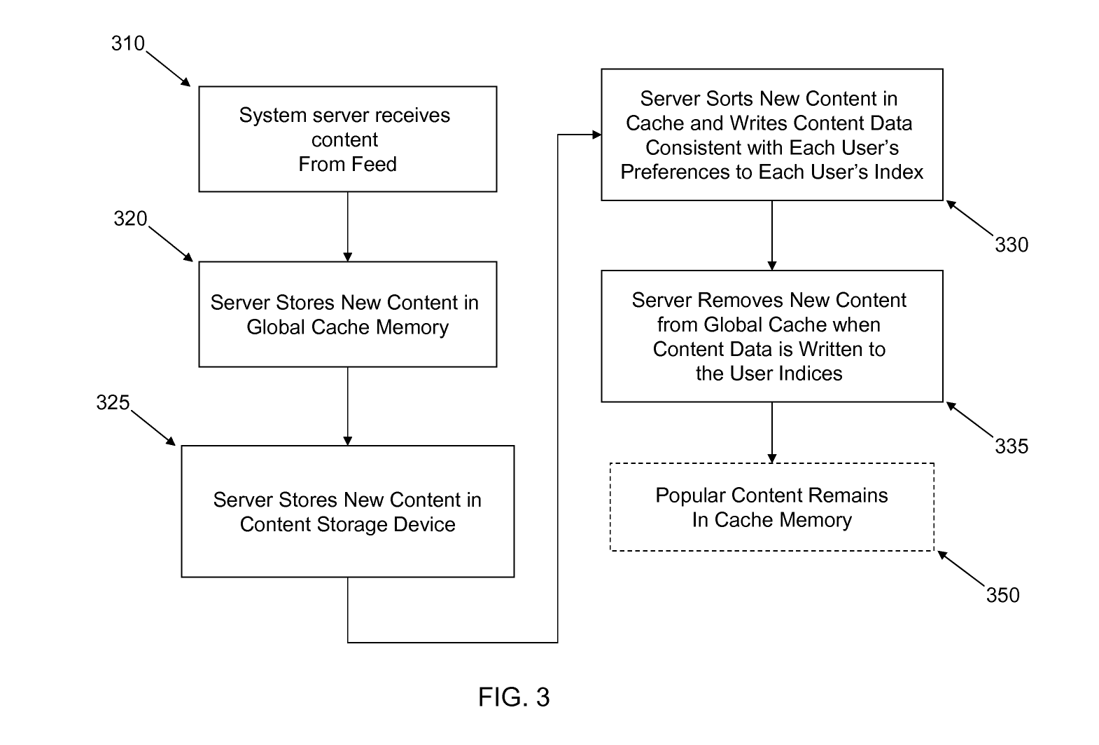

Referring now to FIG. 3 with continued reference to FIG. 2, FIG. 3 illustrates an exemplary flowchart showing the pre processing of new information received by the system 100. The system server 110 receives a plurality of new content from an external source, such as the data feed 310, and stores the new content and content data to a system cache memory 320. Content data stored in the system cache may include metadata, which may include dates, scores, ranking, etcs, as well as pointers to the data in the content storage device. The server stores the new content received in the content storage device 325. The server then sorts the new content in the global data cache memory 130 and, according the to the preferences specified in each user account, writes/stores particular new content data, to the user index files associated with each user account 330.

The server 110 removes the new content and content data, from the global cache memory 130 when the content data associated with the new content, is loaded onto the user index files 340. Content designated popular content, may be retained in the global cache memory 350. Popular content retained in the global cache memory 130 need not be written to the content storage device 120 or the user indices. The popular content designation may be based on frequency of use, content commonality, or other factors.

When each subscriber logs on to the system particular content, content specified in the user index, and new content contained in the global cache memory consistent with the user preference data is presented to the subscriber.

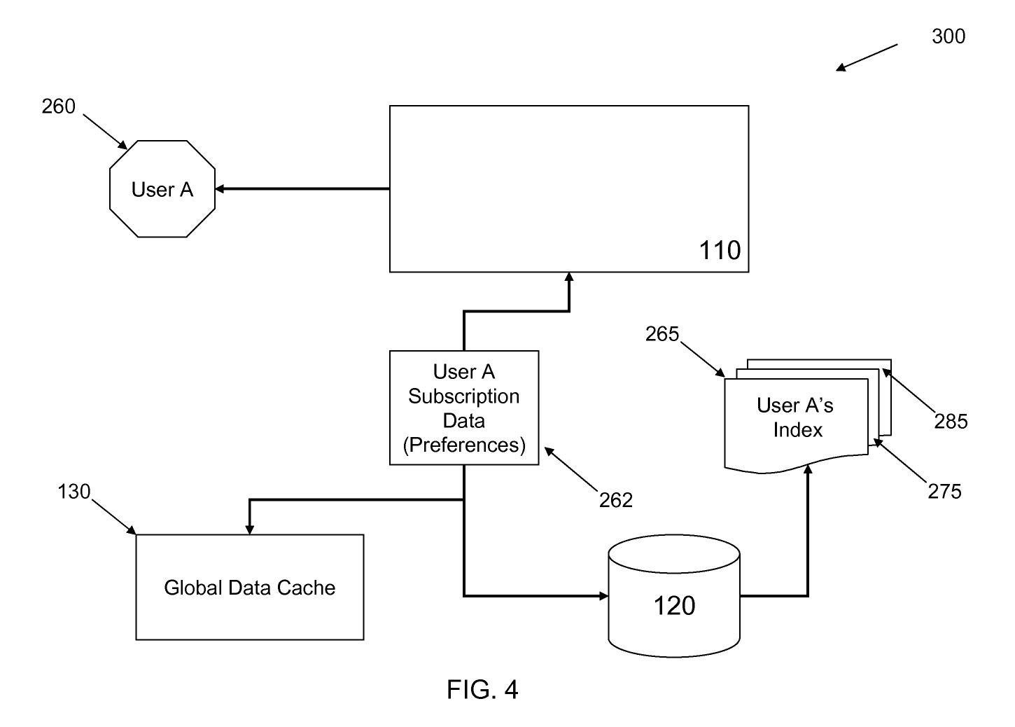

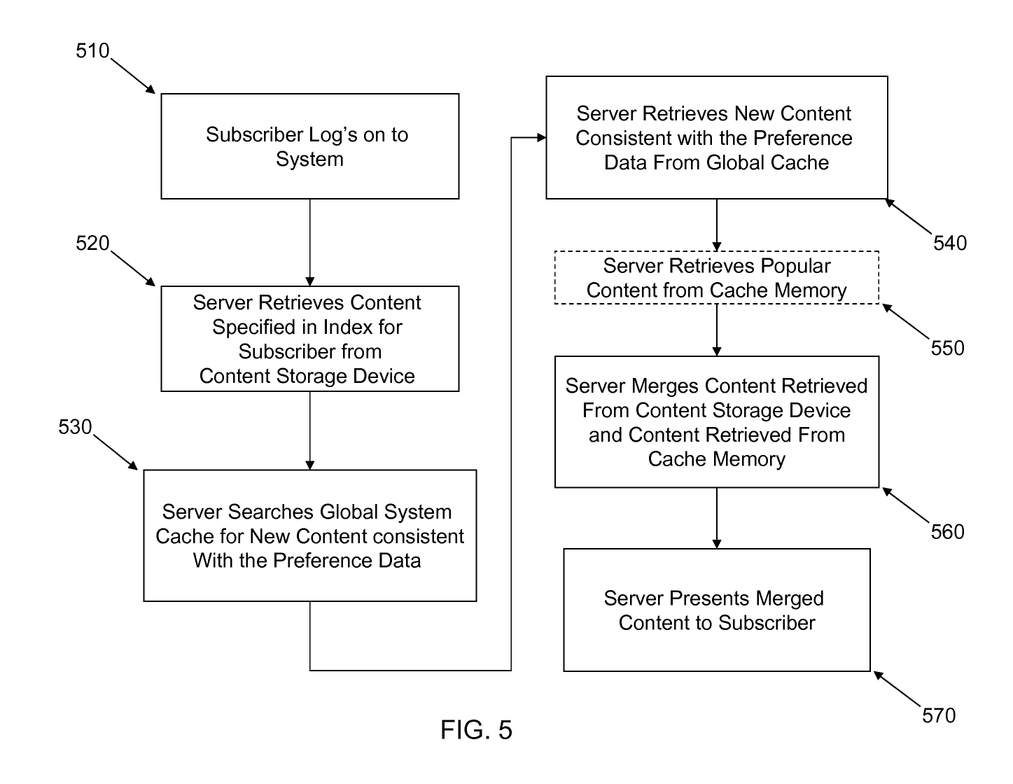

FIG. 4 shows an exemplary flow of information pre-processed and retrieved by the system for an inactive user. FIG. 5 shows an exemplarily flowchart for the storage, merging, and delivery of pre-processed information to a subscriber at logon. Referring now to FIG. 5, with continued reference to FIG. 1, and FIG. 4, a subscriber, (user A) 260, logs on to the system 510. Upon logon, the inactive user's index is rebuilt and the previously inactive user receives new content the system has received and pre processed during the user's inactive period.

Specifically, the server retrieves the content specified in the user index 265 unique to the subscriber (User A) from the content storage device 520. The server 110 also searches the global system cache 130 for new content 530 consistent with the preference data 262. Upon finding new content consistent with the data in the user index 265, the server retrieves the new content consistent with the content data in the user index from the global cache memory 540. If there is content retained in the global cache memory 130 as popular content, the server retrieves the popular content as well 550. The server 110 then merges the content retrieved from the content storage device 120 designated by the content data contained in user index 265, and the content retrieved from the global cache memory 560. The server 110 presents the merged content to the subscriber when the subscriber logs on 570.

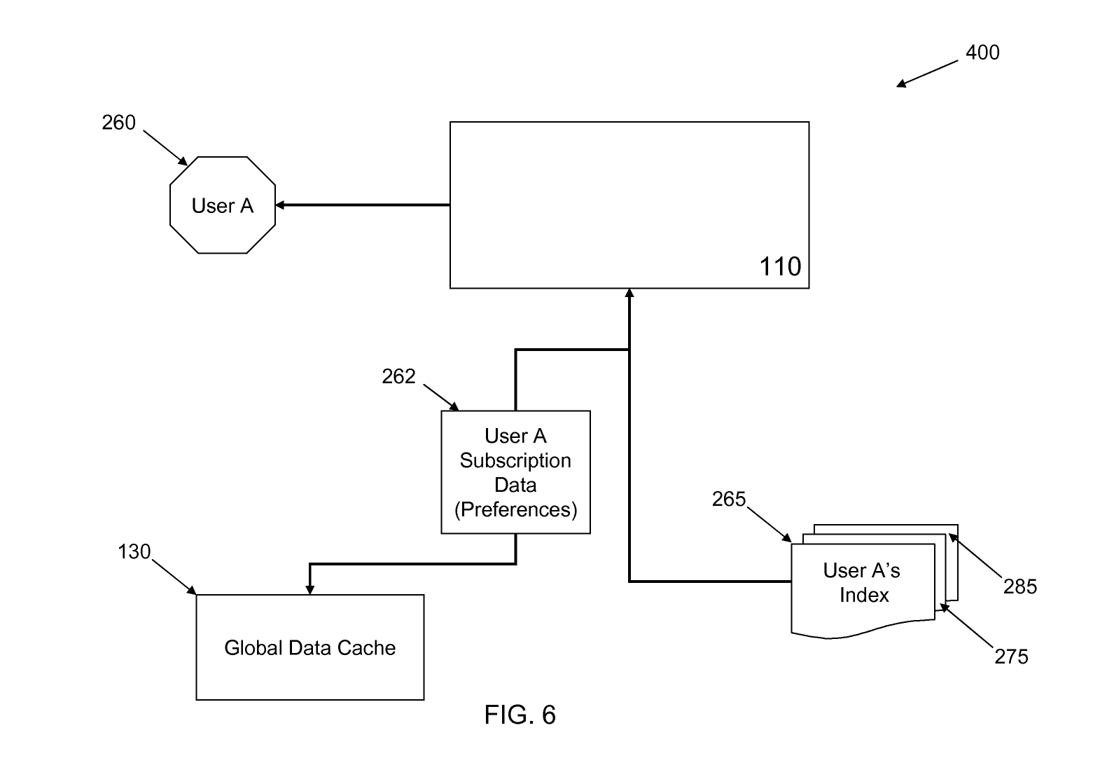

FIG. 6 shows a block diagram illustrating the exemplary flow of information retrieved for an active user. An active user is a user who has already logged on to the system and has an updated user index 265. Referring now to FIG. 6, with continued reference to FIG. 5, during the ongoing processing the user index 265 does not need to be rebuilt. The server 110 retrieves only data that is related to the user's subscription 540 or interest 262 from the global data cache 130. Data from the global data cache 130 and user index 265 is merged 560 by the server 110. This content is retrieved from the global data cache 130 and the content storage device 120, merged and presented to the subscriber 570.

The disclosed invention can take the form of an entirely hardware embodiment, an entirely software embodiment or an embodiment containing both hardware and software elements. In at least one embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory, (CD-ROM), compact disk-read/write (CD-R/W) and DVD.

A data processing system suitable for storing and/or executing program code will include at least one processor coupled directly or indirectly to memory elements through a system bus. The memory elements can include a local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In another example embodiment the system for aggregating information and delivering user specific content including at least one system server computer having a plurality of data feeds operatively coupled thereto, at least one content storage device coupled to the server computer as well as at least one system cache type storage device coupled to the at least one server computer. The system also features at least one user, the user having a user account, the user account providing the user access to the content provided by the server, the user account containing user preference data and a user index associated with each the user account, the user index containing content data specifying content consistent with the user preference data. Upon receiving new content from the data feed, prior to receiving a request from the user for access to content, the at least one system server stores the content in the at least one content storage device coupled to the server, loads new content data into the system's global data cache, classifies the new content loaded into the global data cache based on the user preference data, loads each user index with new data pointers based on the user preferences contained in user account and deletes content from the global data cache as the content data is written onto the user indices.

The system server delivers to the subscriber new content specified in the user index, and new content contained in the global cache memory, when the user request new content. The content data includes data pointers specifying the location of content in the at least one content storage device or other content. In other embodiments the content data may include metadata, data pointers and/or the actual content.

In yet another embodiment the invention takes the form of a method for aggregating selected information and delivering user specific content from a server computer to a user via a client machine coupled to a computer network including storing content received from an external source on a content storage device coupled to the network server, associating a specific user account to the user, defining at least one user account content delivery preference and storing at least one user account content delivery preference on a server computer. The method further includes receiving a plurality of new content from the external source and storing the new content data to a system cache memory as well as sorting the content and new content according to at least one user account preference stored on the server computer and storing new content data specified in the user account delivery preferences in a user index file associated with the user account on the server computer.

The method also includes removing the new content, determined to be consistent with the at least one user account preference, from the system cache memory when the content data associated with the new content, is loaded onto the user index file and presenting the content specified in the user index and new content consistent with the user account preferences contained in the cache memory, to the user when the user logs on to the network.

In other embodiments the method also includes receiving a request for the presentation of content from a user of the network. The method may also include delivering to the subscriber new content specified in the user index and new content contained in the global cache memory when the user request new content. The method may include populating the user index with content data consistent with the users prior content requests and designating new content stored in the system cache memory as popular content, and presenting the popular content contained in the system cache memory to the user when the user logs onto the network.

In yet another embodiment the method includes crawling or monitoring specific data sources or data feeds from a plurality, and sorting, storing and delivering new content from those specific data sources to one or more user indices.

In other embodiments the method includes presenting new content contained in the system cache memory and content similar to content specified by the content data stored in the user index to the user when the user logs onto the network.

In yet another embodiment the invention takes the form of a method for aggregating selected information and delivering user specific content from a server computer to a user via a client machine coupled to a computer network including storing content received from at least one external source to a plurality of content storage devices coupled to the network server, storing content received from at least one external source to a system cache memory and associating a specific user account to each of a plurality of users. The method also includes defining a user account interest model for each of the plurality of users, populating a user index associated with each user account with content data based on the account interest model, searching the cache memory for content identified in each the account interest model and retrieving content identified in each the account interest model from the cache memory as well as content identified by the account index data from the plurality of storage devices and merging the content retrieved from the cache memory with the content retrieved from the plurality of storage devices for each user account, as well as presenting to each user merged content, associated with the user's particular account interest model, when the user logs on to the network.

In yet another embodiment the method may also include receiving a request for the presentation of content from a user of the network.

In yet another embodiment the method also includes populating the user index with content data consistent with the user's prior content requests.

In yet another embodiment the method also includes designating content stored in the system cache memory as popular content, and presenting the popular content contained in the system cache memory to the user when the user logs onto the network.

It will be understood that each block of the flowchart illustrations and block diagrams and combinations of those blocks can be implemented by computer program instructions and/or means.

Although specific example embodiments have been illustrated and described herein, those of ordinary skill in the art appreciate that other variations, aspects, or embodiments may be contemplated, and/or practiced without departing from the scope or the spirit of the appended claims.

1. A system for aggregating information and delivering user specific content comprising:
at least one system server computer having a plurality of data feeds operatively coupled thereto through which said system receives new content;
at least one content storage device coupled to a plurality of client computers through said server computer;
at least one system cache type storage device coupled to said plurality of client computers through said server computer;
a plurality of subscribers, each of said subscriber having a unique user account through which said subscriber uses one of said plurality of client computers to access particular content stored in said content storage device, said user account specifying said subscriber's preference data;
a user index associated with each said unique user account, said user index containing content data specifying particular content according to said subscribers' preferences;
wherein said system server processes said new content received through said data feed by searching, classifying and aggregating said new content received by the system server contained in said system cache and in said at least one content storage device, based on each subscriber's preference data, and delivers user specific content to each subscriber through a client computer coupled to said network when said subscriber logs on to the network.

2. The system of claim 1 wherein said subscriber preference data comprises data that specifies the particular type of content the subscriber wants to receive.

3. The system of claim 2 wherein said system server delivers to said subscriber new content specified in said user index and new content contained in said global cache memory when said user request new content.

4. The system of claim 3 wherein said at least one system server stores at least one user index.

5. The system of claim 4 wherein said at least one user index comprises content data for new content received by said system server while said user account is inactive.

6. The system of claim 5 wherein said global system cache comprises content data for new content received by said system server not written to said user index.

7. The system of claim 6 wherein said global system cache comprises new content received by said system server.

8. The system of claim 7 wherein said system server delivers to said subscriber new content specified in said user index and new content contained in said global cache memory when said user logs onto the system.

9. A system for aggregating information and delivering user specific content comprising:
at least one system server computer having a plurality of data feeds operatively coupled thereto;
at least one content storage device coupled to said server computer,
at least one system cache type storage device coupled to said at least one server computer;
at least one user, said user having a user account, said user account providing said user access to said content provided by said server, said user account containing user preference data;
a user index associated with each said user account, said user index containing content data specifying content consistent with said user preference data;
wherein upon receiving new content from said data feed, prior to receiving a request from said user for access to content, said at least one system server stores said content in said at least one content storage device coupled to said server, loads new content data into said system's global data cache, classifies said new content loaded into said global data cache based on said user preference data, loads each user index with new data pointers based on said user preferences contained in user account and deletes content from said global data cache as said content data is written onto said user indices.

10. The system of claim 9 wherein said system server delivers to said subscriber new content specified in said user index and new content contained in said global cache memory when said user request new content.

11. The system of claim 10 wherein said content data comprises data pointers specifying the location of content in said at least one content storage device.

12. The system of claim 11 wherein said global cache memory contains new content received by the system server.

13. A method for aggregating selected information and delivering user specific content from a server computer to a user via a client machine coupled to a computer network comprising:
storing content received from an external source on a content storage device coupled to said network server;
associating a specific user account to the user;
defining at least one user account content delivery preference;
storing at least one user account content delivery preference on a server computer;
receiving a plurality of new content from said external source;
storing said new content data to a system cache memory;
sorting said content and new content according to at least one user account preference stored on said server computer;
storing new content data specified in said user account delivery preferences in a user index file associated with said user account on said server computer;
removing said new content, determined to be consistent with said at least one user account preference, from said system cache memory when said content data associated with said new content, is loaded onto said user index file;
presenting said content specified in said user index and new content consistent with said user account preferences contained in said cache memory, to said user when said user logs on to the network.

14. The method of claim 13 further comprising the method step of:
receiving a request for the presentation of content from a user of the network.

15. The method of claim 14 further comprising the method step of delivering to said subscriber new content specified in said user index and new content contained in said global cache memory when said user request new content.

16. The method of claim 13 further comprising the method step of:
populating said user index with content data consistent with said users prior content requests.

17. The method of claim 13 further comprising the method step of:
designating new content stored in said system cache memory as popular content, and presenting said popular content contained in said system cache memory to said user when the user logs onto the network.

18. The method of claim 14 further comprising the method step of:
presenting new content contained in said system cache memory and content similar to content specified by said content data stored in said user index to said user when the user logs onto the network.

19. A method for aggregating selected information and delivering user specific content from a server computer to a user via a client machine coupled to a computer network comprising:
storing content received from at least one external source to a plurality of content storage devices coupled to said network server;
storing content received from at least one external source to a system cache memory;
associating a specific user account to each of a plurality of users;
defining a user account interest model for each of the plurality of users;
populating a user index associated with each user account with content data based on said account interest model;
searching said cache memory for content identified in each said account interest model;
retrieving content identified in each said account interest model from said cache memory;
retrieving content identified by said account index data from said plurality of storage devices;
merging said content retrieved from said cache memory with said content retrieved from said plurality of storage devices for each user account;
presenting to each user merged content, associated with said user's particular account interest model, when said user logs on to the network.

20. The method of claim 19 further comprising the method step of:
receiving a request for the presentation of content from a user of the network.

21. The method of claim 20 further comprising the method step of:
populating said user index with content data consistent with said users prior content requests.

22. The method of claim 21 further comprising the method step of:
designating content stored in said system cache memory as popular content, and presenting said popular content contained in said system cache memory to said user when the user logs onto the network.
